(19) United States
(12) Patent Application Publication
(10) Pub. No.: US 2026/0023307 A1
(43) Pub. Date: Jan. 22, 2026

(54) HOLDING MEMBER, LENS BARREL, AND IMAGE PICKUP APPARATUS

(71) Applicant: CANON KABUSHIKI KAISHA, Tokyo (JP)

(72) Inventors: TORU ISHIMASA, Kanagawa (JP); TOSHIHIRO OGAWA, Tokyo (JP); SHINYA HATTORI, Kanagawa (JP); TAKAHISA WATANABE, Chiba (JP); YUKIYA KOSEKI, Kanagawa (JP)

(21) Appl. No.: 19/261,084

(22) Filed: Jul. 7, 2025

(30) Foreign Application Priority Data
Jul. 17, 2024 (JP) 2024-114264

(51) Int. Cl. G03B 17/12; G02B 7/02; G03B 17/56

(52) U.S. Cl. CPC G03B 17/12; G02B 7/022; G02B 7/025; G03B 17/566

(57) ABSTRACT

A holding member includes a holder configured to hold a lens, and an outer circumference portion integrally molded with the holder and disposed on an outer circumference of the holder. The holder has a plurality of penetrating grooves along a circumferential direction, on an outer circumference side of a plurality of contact portions that contact the lens when viewed from an optical axis direction.

### BACKGROUND

### Field of the Technology

The present disclosure relates to a holding member, a lens barrel, and an image pickup apparatus.

### Description of the Related Art

A lens holding frame has recently been used for an optical apparatus such as digital cameras, video cameras, and interchangeable lenses to reduce impacts and stress on lenses.

Japanese Patent Application Laid-Open No. 2015-169916 discloses a lens holding frame that includes a cylindrical member, and a lens holding member disposed on the inner circumference side of the cylindrical member and holding a lens, wherein in a case where the cylindrical member receives an external force, part of the lens holding member is elastically deformed.

However, in the lens holding frame disclosed in Japanese Patent Application Laid-Open No. 2015-169916, in a case where a strong impact is applied to the cylindrical member, the lens holding member that is partially elastically deforms may get damaged and the held lens may also get damaged.

### SUMMARY

A holding member according to one aspect of the present disclosure includes a holder configured to hold a lens, and an outer circumference portion integrally molded with the holder and disposed on an outer circumference of the holder. The holder has a plurality of penetrating grooves along a circumferential direction, on an outer circumference side of a plurality of contact portions that contact the lens when viewed from an optical axis direction. A lens barrel and an image pickup apparatus each having the above holding member also constitute another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of a camera system according to this embodiment of the present disclosure.

FIG. 2 is a block diagram illustrating electrical and optical configurations of the camera system.

FIG. 3 is a sectional view of an interchangeable lens at a wide-angle end.

FIG. 4 is a sectional view of the interchangeable lens at a telephoto end.

FIG. 5 is a sectional view of the interchangeable lens at a retraction end.

FIGS. 6A and 6B explain a first zoom unit.

FIG. 7 illustrates a first lens holding frame when viewed from an optical axis direction.

FIGS. 8A, 8B, and 8C explain the first lens holding frame.

FIGS. 9A and 9B explain the first lens holding frame.

FIG. 10 is a side view of the camera system suspended by a strap.

FIG. 11 is a front view of the camera system suspended by the strap.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

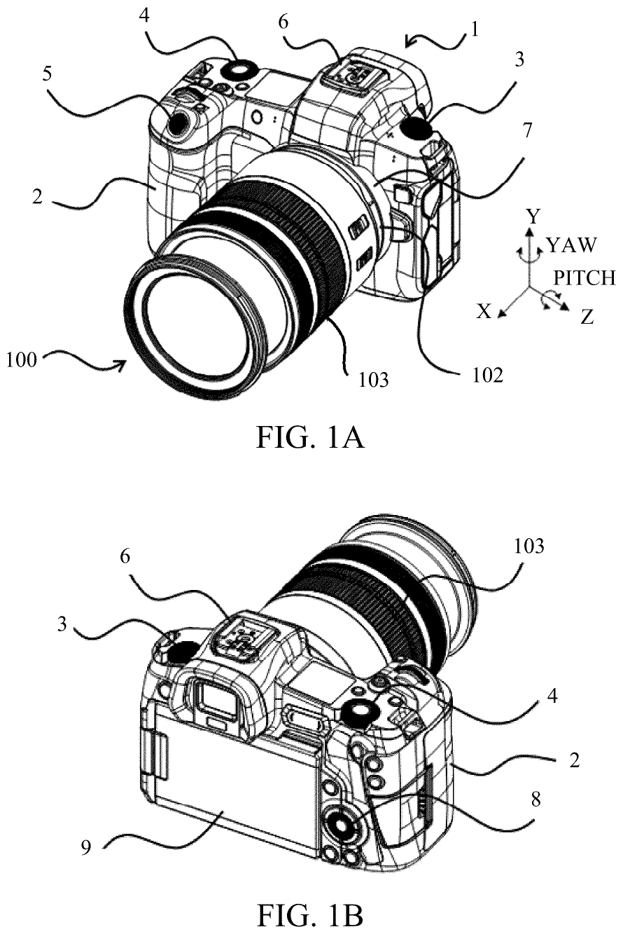

FIGS. 1A and 1B are perspective views of a camera system (image pickup apparatus) according to this embodiment of the present disclosure. The camera system includes an interchangeable lens (lens barrel) 100 and a digital camera (referred to as a camera body hereinafter) 1 to which the interchangeable lens 100 is detachably attached. Although the configuration of the interchangeable lens 100 will be described in this embodiment, the present disclosure is also applicable to another optical apparatus such as a lens integrated camera.

FIGS. 1A and 1B illustrate the camera system viewed from the front side (object side) and the back side (imaging surface side), respectively. In this embodiment, as illustrated in FIG. 1A, an optical axis direction, which is a direction in which an optical axis of the imaging optical system housed in the interchangeable lens 100 extends (a direction along the optical axis), is defined as an X-axis direction, and directions orthogonal to this direction are defined as a Z-axis direction (horizontal direction) and a Y-axis direction (vertical direction). Hereinafter, the Z-axis direction and the Y-axis direction will be collectively referred to as a Z/Y-axis direction. A rotation direction around the Z-axis is defined as a pitch direction, and a rotation direction around the Y-axis is defined as a yaw direction. The pitch direction and yaw direction (collectively referred to as the pitch/yaw direction hereinafter) are rotating directions around two mutually orthogonal axes, the Z-axis and the Y-axis.

A grip portion 2 for the user to hold camera body 1 with his hand is provided on the left side when viewed from the front side of camera body 1 (right side when viewed from the rear side).

A power operation unit 3 is provided on a top surface of camera body 1. In a case where the user turns on power operation unit 3 while the camera body 1 is in the power-off state, electricity is started and camera body 1 is turned on, and a computer program such as origin detection processing for a focus unit is executed, and the camera body is in a standby state for imaging. In a case where the user turns off the power operation unit 3 while the camera body 1 is in the power-on state, the camera body 1 is turned off.

A mode dial 4, a release button 5, and an accessory shoe 6 are provided on the top surface of camera body 1. The user can switch an imaging mode by rotating the mode dial 4. The imaging mode includes a manual still image capturing mode in which the user can set an imaging condition such as a shutter speed and an aperture value (F-number), an auto still image capturing mode in which proper exposure is automatically obtained, and a moving image capturing mode for capturing a moving image. The user can instruct an imaging preparation operation such as autofocus (AF) and auto-exposure (AE) control by half-pressing the release button 5, and can instruct imaging by fully pressing the button. An accessory (camera accessory) such as an external flash is detachably attached to the accessory shoe 6.

The interchangeable lens 100 includes a lens mount 102 that can be mechanically and electrically connected to a camera mount 7 provided on the camera body 1. The lens mount 102 and the camera mount 7, each of which has a circular ring shape, are made of metal material and can be attached and detached via a bayonet connection (not illustrated). There are no restrictions on the combination of the interchangeable lens 100 and the camera body 1 as long as they use a common mount shape as the camera system.

The interchangeable lens 100 includes an imaging optical system that forms an object image using light from an object.

The outer circumference of the interchangeable lens 100 is provided with a zoom operation ring 103 rotatable around the optical axis by a user operation. In a case where the zoom operation ring 103 is rotated by the user, a zoom unit in the imaging optical system moves to a predetermined usage position corresponding to an angle of the zoom operation ring 103, within a range from the wide-angle end to the telephoto end. This configuration enables the user to perform imaging at a desired angle of view. In this embodiment, a retraction end is provided outside the range where the zoom operation ring 103 is rotated from the telephoto end to the wide-angle end, where the imaging is restricted. The retraction end is a position where the interchangeable lens 100 is most retracted.

As illustrated in FIG. 1B, a rear operation unit 8 and a display unit 9 are provided on the rear surface of the camera body 1. The rear operation unit 8 includes a plurality of buttons and dials to which various functions are assigned. In a case where the camera body 1 is powered on and the still or moving image capturing mode is set, a through-image of an object image formed on an image sensor, which will be described later, is displayed on the display unit 9. The display unit 9 also displays imaging parameters indicating imaging conditions such as a shutter speed and an aperture value, and the user can change the settings of the imaging parameters by operating the rear operation unit 8 while viewing the display. The rear operation unit 8 includes a playback button for instructing playback of a recorded captured image, and the captured image is played back and displayed on the display unit 9 in a case where the user operates the playback button. The display unit 9 may be of a touch panel type and have the same functions as the rear operation unit 8.

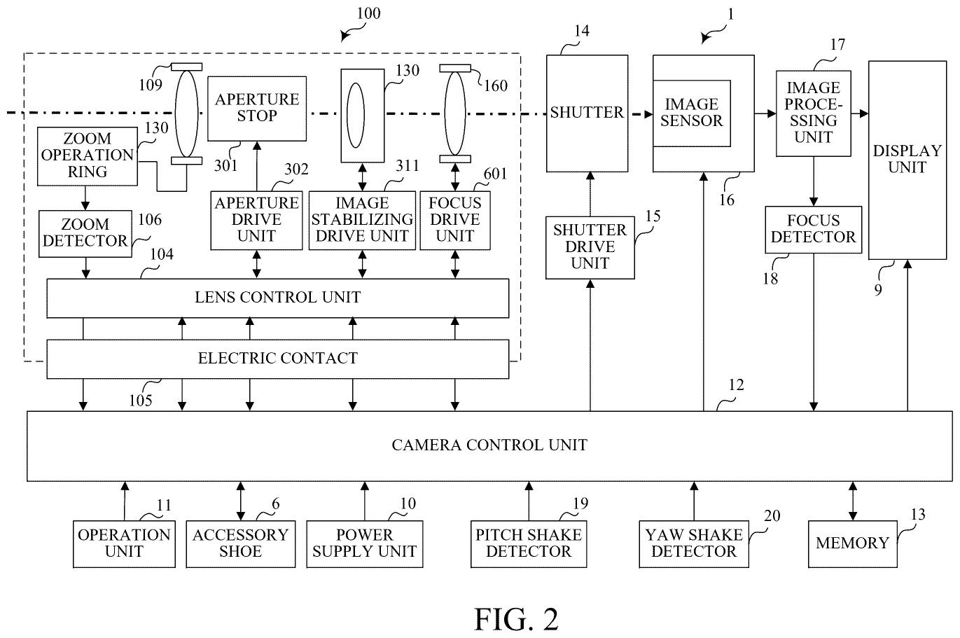

FIG. 2 is a block diagram illustrating the electrical and optical configuration of the camera system. The camera body 1 includes a power supply unit 10 that supplies power to the camera body 1 and the interchangeable lens 100, and an operation unit 11 that includes the power operation unit 3, mode dial 4, release button 5, rear operation unit 8, and the touch panel function of the display unit 9.

In this embodiment, the camera system is controlled by a camera control unit 12 provided in the camera body 1 and a lens control unit 104 provided in the interchangeable lens 100 working together. Each of the camera control unit 12 and the lens control unit 104 has a built-in computer for controlling the camera body 1 and the interchangeable lens 100, respectively, and the camera system is controlled by linking them. The camera control unit 12 reads out and executes a computer program stored in the memory 13. At that time, the camera control unit 12 communicates with the lens control unit 104 via a communication terminal of an electrical contact 105 provided on the lens mount 102, and communicates various control signals, data, and the like. The electrical contact 105 includes a power supply terminal that supplies power from the power supply unit 10 to the interchangeable lens 100.

The imaging optical system in the interchangeable lens 100 includes a zoom unit 109 that is connected to the zoom operation ring 103 and moves in the optical axis direction to change an angle of view, and an aperture stop unit 301 that adjusts a light amount. The imaging optical system further includes a shift lens as an image stabilizing element, and includes a lens image stabilizing unit 130 that reduces image blur by moving (shifting) in the Z/Y axis directions orthogonal to the optical axis. The imaging optical system further includes a focus unit 160 including a focus lens that moves in the optical axis direction for focusing.

The interchangeable lens 100 includes an aperture drive unit 302 that drives the aperture stop unit 301, an image stabilizing drive unit 311 that moves the lens image stabilizing unit 130, and a focus drive unit 601 that moves the focus unit 160.

The camera body 1 includes a shutter unit 14, a shutter drive unit 15, an image sensor 16, an image processing unit 17, and a camera control unit 12. The shutter unit 14 controls a light amount exposed by the image sensor 16. The image sensor 16 photoelectrically converts an object image formed by the imaging optical system and outputs an imaging signal. The image processing unit 17 generates an image signal after performing various image processing for the imaging signal. The display unit 9 displays the image signal (through-image) output from the image processing unit 17, displays the imaging parameter as described above, and plays back and displays the captured image recorded in the memory 13 or a recording medium (not illustrated).

The camera control unit 12 controls the focus drive unit 601 according to an imaging preparation operation (such as half-pressing of the release button 5) in the operation unit 11. For example, in a case where an AF operation is instructed, a focus detector 18 determines a focus state of an object image formed on the image sensor 16 based on an image signal generated by the image processing unit 17, generates a focus signal, and transmits it to the camera control unit 12. At the same time, the focus drive unit 601 transmits information on the current position of the focus unit 160 to the camera control unit 12. The camera control unit 12 compares the focus state of the object image with the current position of the focus unit 160, calculates a focus drive amount from a shift amount, and transmits it to the lens control unit 104. The lens control unit 104 then moves the focus unit 160 to a target position in the optical axis direction via the focus drive unit 601, and corrects a defocus state of the object image.

The focus drive unit 601 includes a focus motor that functions as an actuator, and a photo-interrupter that serves as a detector that detects an origin position of the focus unit 160. Generally, a stepping motor, which is a type of actuator, is often used as the focus motor. A DC motor or ultrasonic motor equipped with an encoder, or a servo motor, etc. may be used as the focus motor. The photo-interrupter receives light emitted from a light emitting unit directly at a light receiver, but instead of this, a photo-reflector that receives reflected light from a reflective surface or a brush that contacts a conductive pattern to electrically detect a signal may be used as the detector.

The camera control unit 12 controls the driving of the aperture stop unit 301 and the shutter unit 14 via the aperture drive unit 302 and the shutter drive unit 15 according to the aperture value and shutter speed settings received from the operation unit 11. For example, in a case where an AE control operation is instructed, the camera control unit 12 receives a luminance signal generated by the image processing unit 17 and performs a photometric calculation. Based on the result of this photometric calculation, the camera control unit 12 controls the aperture drive unit 302 according to an imaging instruction operation (such as full pressing of the release button 5) on the operation unit 11. At the same time, the camera control unit 12 controls the driving of the shutter unit 14 via the shutter drive unit 15, and performs exposure processing by the image sensor 16.

The camera body 1 has a pitch shake detector 19 and a yaw shake detector 20 as a shake detector configured to detect image shake caused by the user's hand shake, etc. The pitch shake detector 19 and yaw shake detector 20 respectively use an angular velocity sensor (vibration gyro) and an angular acceleration sensor to detect image shake in the pitch direction and yaw direction and output a shake signal. The camera control unit 12 uses the shake signal from the pitch shake detector 19 to calculate the shift position of the lens image stabilizing unit 130 in the Y-axis direction. Similarly, the camera control unit 12 uses a shake signal from the yaw shake detector 20 to calculate a shift position of the lens image stabilizing unit 130 in the Z-axis direction. The camera control unit 12 then moves the lens image stabilizing unit 130 to a target position in the Z/Y axis direction via the image stabilizing drive unit 311 according to the calculated shift position in the pitch/yaw direction, reducing image blur during exposure or during display of a through-image.

The interchangeable lens 100 includes a zoom operation ring 103 for changing an angle of view of the imaging optical system, and a zoom detector 106 configured to detect an angle of the zoom operation ring 103. The zoom detector 106 detects an angle of the zoom operation ring 103 operated by the user as an absolute value, and includes, for example, a resistive linear potentiometer. Information on the angle of view detected by the zoom detector 106 is transmitted to the lens control unit 104 and reflected in various controls by the camera control unit 12. Part of this information is recorded in the memory 13 or a recording medium (not illustrated) together with the captured image.

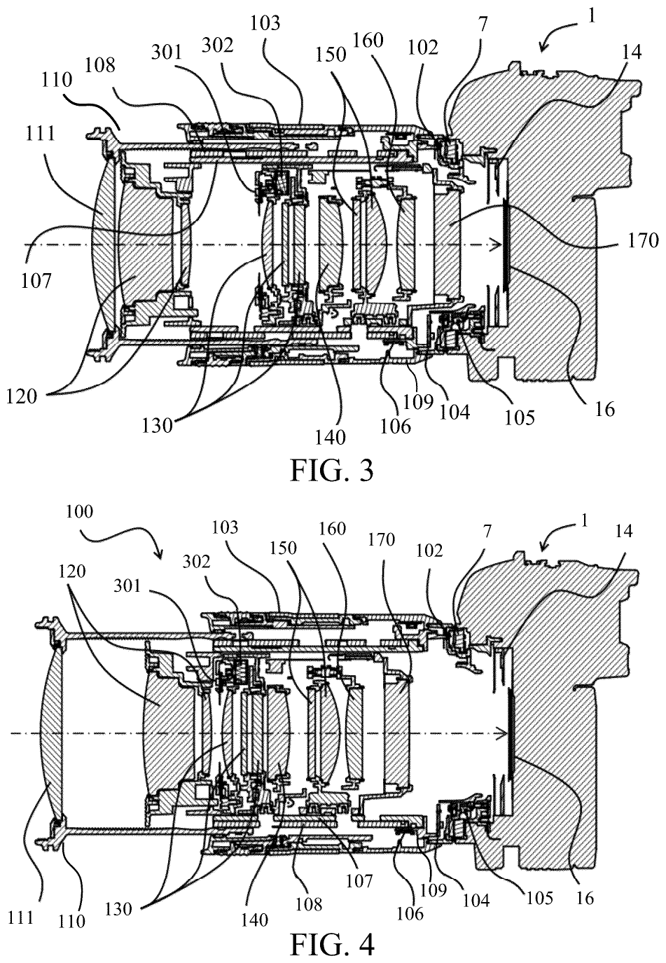

The positional relationship of the main components of the interchangeable lens 100 will be described below. FIGS. 3 to 5 are sectional views on an XY plane including the optical axis. A centerline illustrated here is approximately the same as the optical axis determined by the imaging optical system, and is therefore hereinafter synonymous with the optical axis.

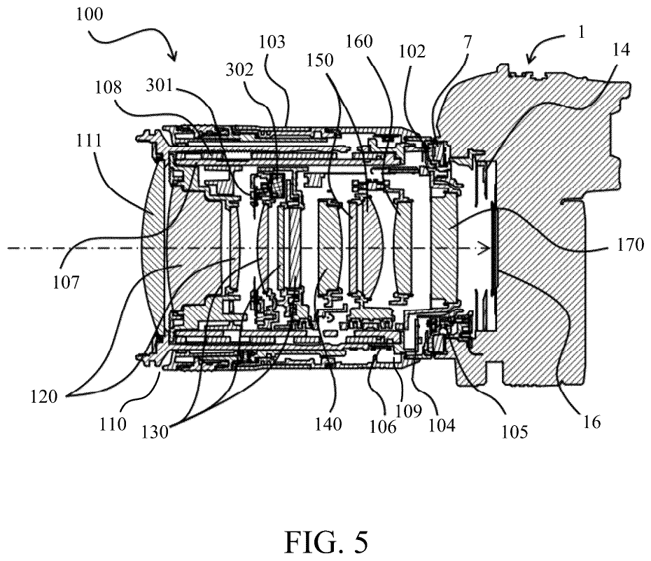

FIG. 3 illustrates the wide-angle end on the short focal side in the zoom, and FIG. 4 illustrates the telephoto end on the long focal side in the zoom. FIG. 5 illustrates the retraction end at which the overall length is the shortest in the optical axis direction. The retraction end in FIG. 5 is provided further beyond the wide-angle end in FIG. 3, and by rotating the zoom operation ring 103 in one direction, the retraction end in FIG. 5 moves from the wide-angle end in FIG. 3 to the wide-angle end in FIG. 3, and then from the wide-angle end in FIG. 3 to the telephoto end in FIG. 4.

In FIGS. 3 and 4, the camera system is in an imageable state where the imaging optical system is located at an imageable position (imaging state). The imageable state means a state in which the functions of the camera system can operate normally. In FIG. 5, the camera system is in a state where the imaging optical system is located at a retraction position and imaging is restricted (retracted state). A state where imaging is restricted means a state where some of the functions of the camera system do not operate normally. For example, imaging is available in the retracted state, (for example, pressing the shutter for imaging an object), but the image may be out of focus or the like, resulting in a partially or entirely blurred image.

As illustrated in FIGS. 3 and 4, this embodiment adopts a seven-unit configuration as an example of an imaging optical system. The zoom unit 109 moves to different predetermined use positions at the wide-angle end and the telephoto end, respectively, and guides light from the object to the image sensor 16. The zoom unit 109 includes a first zoom unit 110, a second zoom unit 120, a lens image stabilizing unit 130 functioning as a third zoom unit, a fourth zoom unit 140, a fifth zoom unit 150, a focus unit 160 functioning as a sixth zoom unit, and a seventh zoom unit 170. The zoom unit 109 may also have an aperture stop unit 301. The imaging optical system is not limited to the seven-unit configuration. For example, the lens image stabilizing unit 130 and the focus unit 160 may function as another zoom unit. Some lens units may be fixed rather than movable.

A linear guide barrel 107 is a fixed part fixed to the lens mount 102 via the fixed barrel 101. Bayonet claws (not illustrated) are placed at regular intervals on the outer circumferential surface of the linear guide barrel 107. A circumferential groove (not illustrated) is provided on the inner circumferential surface of a cam barrel 108. The cam barrel 108 is connected to the zoom operation ring 103. In a case where the user rotates the zoom operation ring 103, the bayonet claws are engaged with the circumferential grooves to restrict the cam barrel 108 from moving in the optical axis direction, and the cam barrel 108 rotates around the optical axis.

The linear guide barrel 107 has linear guide grooves formed at regular intervals that restrict the movement of the zoom unit 109 in the rotation direction and guide the linear movement in the optical axis direction. The cam barrel 108 has cam grooves at regular intervals, each of which has a different angle in the rotational direction corresponding to the zoom unit 109. The zoom unit 109 has a plurality of rollers, each of which is engaged with a corresponding linear guide groove and cam groove. In a case where the user rotates the zoom operation ring 103, the cam barrel 108 rotates, and the rollers move the zoom unit 109 back and forth in the optical axis direction while restricting movement in the rotational direction by the engagement with the linear guide grooves and the cam grooves.

In this embodiment, the interchangeable lens 100 has a retractable (collapsible) mechanism, so that the zoom unit 109 can be retracted further toward the rear side (imaging surface side) during non-imaging. Thereby, the overall length of the interchangeable lens 100 can be reduced, and the portability of the interchangeable lens 100 and the camera body 1 can be improved.

At the wide-angle end in FIG. 3, a distance between the second zoom unit 120 and the lens image stabilizing unit 130 functioning as the third zoom unit is wide, and at the telephoto end in FIG. 4, a distance between the first zoom unit 110 and the second zoom unit 120 is wide. The retractable mechanism narrows each of these distances, moves them to housed positions close to each other, and reduces the overall length in the optical axis direction. At the retraction end during non-imaging in FIG. 5, the zoom unit 109 have moved to a housed position where its parts are close to each other. From the state in FIG. 5, for example, in a case where the user rotates the zoom operation ring 103 to the wide-angle end, the zoom unit 109 extends to the front side (object side) and moves to a predetermined use position, thereby enabling the user to perform imaging as illustrated in FIG. 3.

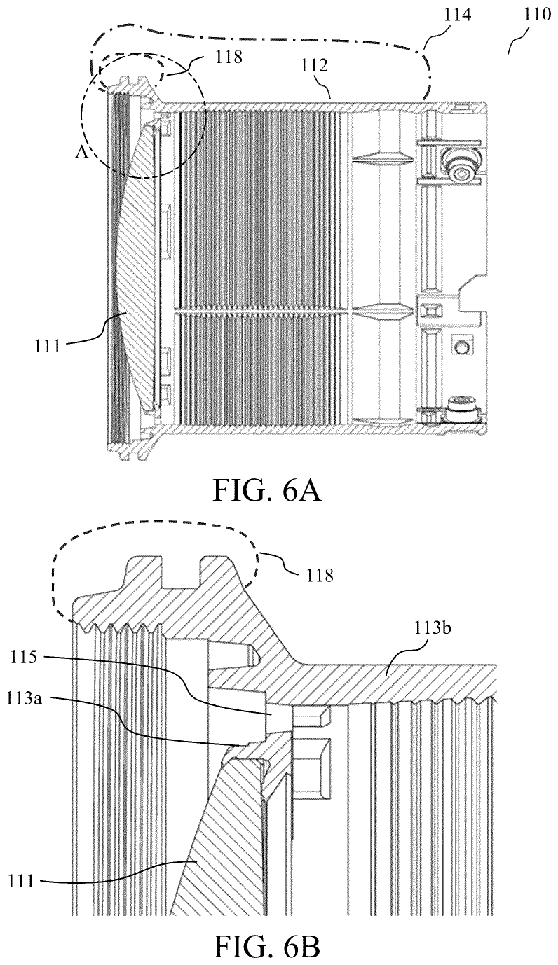

The shape of the first zoom unit 110 will be described below. FIGS. 6A and 6B explain the first zoom unit 110. FIG. 6A is a sectional view of the first zoom unit 110. FIG. 6B is an enlarged view of a tip portion A of the first zoom unit 110 illustrated in FIG. 6A.

The first zoom unit 110 includes a first lens 111, a first lens holding frame 112, and a name ring (not illustrated). The first lens holding frame 112 has a lens holder (holder) 113a that holds the first lens 111, and an outer circumference portion 113b that is integrally molded with the lens holder 113a and is disposed on the outer circumference of the lens holder 113a. An outer appearance portion 114 that forms the outer appearance is disposed on the outer circumference of the first lens holding frame 112. In this embodiment, the lens holder 113a holds the first lens 111 near the center when viewed from the optical axis direction. The lens holder 113a holds the first lens 111 by caulking (crimping). More specifically, in this embodiment, the lens holder 113a has a caulking claw shape, and the first lens 111 is held in the first lens holding frame 112 by thermal caulking. As long as the first lens 111 is held in the first lens holding frame 112, the shape and method are not limited.

When viewed from the optical axis direction, the lens holder 113a has a plurality of penetrating grooves 115 along the circumferential direction, on the outer circumferential side of a plurality of contact portions where the lens holder 113a contacts the first lens 111. Each of the plurality of penetrating grooves 115 has an arc shape.

An accessory attachment portion (attachment portion) 118 for attaching accessory is provided on part of the outer circumference of the outer circumference portion 113b. The accessory attachment portion 118 is located on the outermost circumference of the first lens holding frame 112. The accessory attachment portion 118 is also located outside the lens holder 113a in the optical axis direction. In other words, the accessory attachment portion 118 is provided so that it does not overlap the lens holder 113a in the optical axis direction.

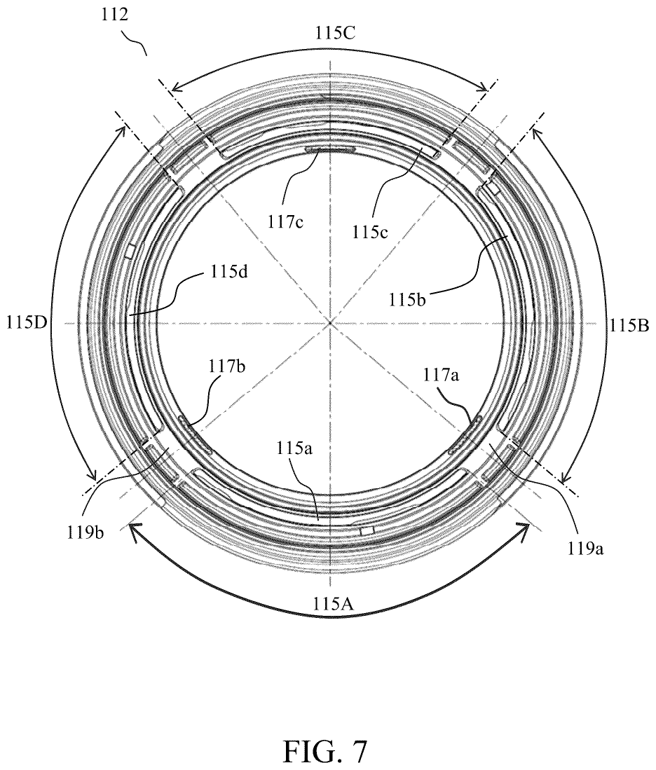

FIG. 7 illustrates the first lens holding frame 112 viewed from the optical axis direction. As described above, the first lens holding frame 112 has a plurality of penetrating grooves 115. In this embodiment, the plurality of penetrating grooves 115 are four penetrating grooves 115a, 115b, 115c, and 115d. The penetrating grooves 115a, 115b, 115c, and 115d are provided at regular intervals along the circumferential direction, and in this embodiment, they are provided on the lower, right, upper, and left sides, respectively, in the camera normal attitude (the attitude in a case where the camera system is used in the state of FIGS. 1A and 1B). Of circumferential ranges 115A, 115B, 115C, and 115D of the penetrating grooves 115a, 115b, 115c, and 115d, the circumferential range 115A of the penetrating groove 115a located at the lowermost position is the widest. Joint portions 119a and 119b connect the lens holder 113a and the outer circumference portion 113b.

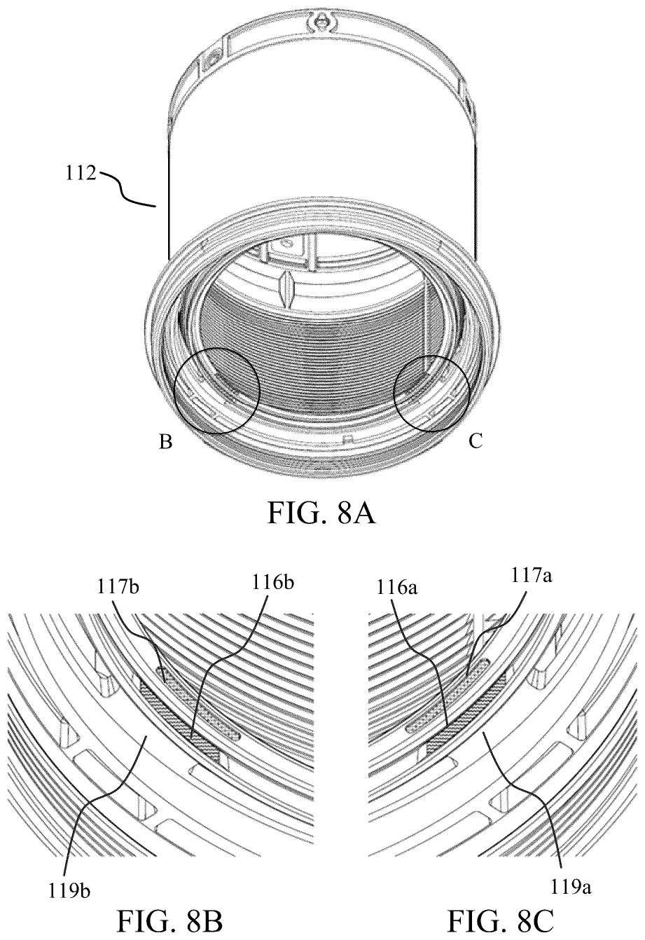

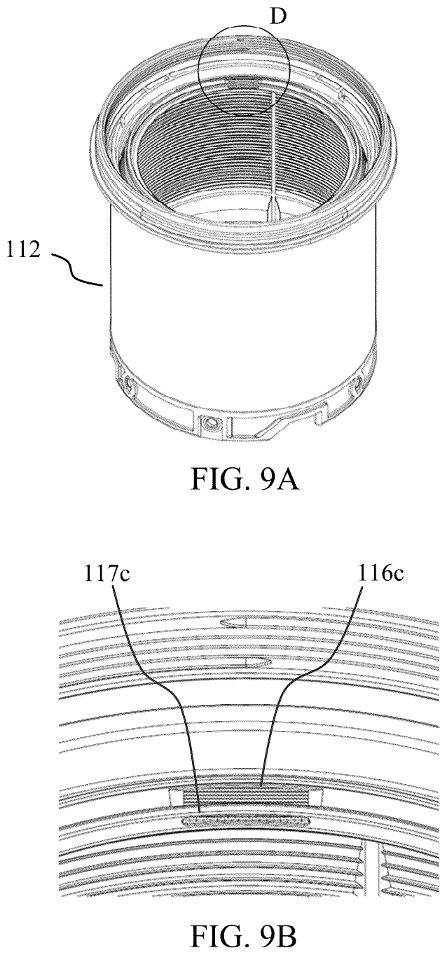

FIGS. 8A, 8B, 8C, 9A, and 9B explain the first lens holding frame 112. FIG. 8A is a perspective view of the first lens holding frame 112 when viewed from above in the camera normal attitude. FIGS. 8B and 8C are enlarged views of areas B and C in FIG. 8A, respectively. FIG. 9A is a perspective view of the first lens holding frame 112 when viewed from below in the camera normal attitude. FIG. 9B is an enlarged view of area D in FIG. 9A.

The first lens holding frame 112 has lens receiving surfaces 117a, 117b, and 117c on the inner diameter side of the lens holder 113a. The lens receiving surfaces 117a, 117b, and 117c contact the first lens 111 in the optical axis direction. The first lens holding frame 112 has lens engagement portions 116a and 116b on the lower side and lens engagement portion 116c on the upper side on the inner diameter side of the lens holder 113a in the camera normal attitude. The lens engagement portions 116a, 116b, and 116c are engaged with a part of the outer circumference surface of the first lens 111. When viewed from the optical axis direction in the camera normal attitude, the lens engagement portions 116a, 116b, and 116c are arranged in the same phase (same position in the circumferential direction) as those of the lens receiving surfaces 117a, 117b, and 117c, respectively. In this embodiment, a contact portion that contacts the first lens 111 is formed by the lens engagement portions and the lens receiving surfaces arranged in the same phase. The “same phase” does not only mean the exact same phase, but also includes the case where the lens engagement portions are substantially in the same phase (approximately in the same phase).

When viewed from the optical axis direction in the camera normal attitude, on the lower side, as illustrated in FIGS. 7, 8A, 8B, and 8C, the lens engagement portion 116a and the lens receiving surface 117a are disposed in the same phase (including approximately the same phase) as that of the joint portion 119a. The lens engagement portion 116b and the lens receiving surface 117b are disposed in the same phase (including approximately the same phase) as that of the joint portion 119b. That is, the lens engagement portion 116a and the lens receiving surface 117a, as well as the lens engagement portion 116b and the lens receiving surface 117b, are disposed so that they do not overlap the penetrating groove in the circumferential direction. In this embodiment, the lens engagement portion 116a and the lens receiving surface 117a form a first contact portion. Similarly, the lens engagement portion 116b and the lens receiving surface 117b form a first contact portion.

When viewed from the optical axis direction in the camera normal attitude, on the upper side, as illustrated in FIGS. 7, 9A, and 9B, the lens engagement portion 116c and the lens receiving surface 117c are disposed so that they overlap the penetrating groove 115c in the circumferential direction. In this embodiment, the lens engagement portion 116c and the lens receiving surface 117c form a second contact portion. In this embodiment, the lens engagement portion 116c and the lens receiving surface 117c are disposed at the center of the penetrating groove 115c. The center does not only mean the exact center, but also includes the substantial center (approximate center).

When viewed from the optical axis direction in the camera normal attitude, the penetrating groove 115a is formed under the first lens holding frame 112, and the joint portions 119a and 119b are provided on both ends of it. As described above, the lens engagement portion 116a and the lens receiving surface 117a are disposed in the same phase as that of the joint portion 119a, and the lens engagement portion 116b and the lens receiving surface 117b are disposed in the same phase as that of the joint portion 119b. Due to this configuration, the first lens 111 does not come into contact with the first lens holding frame 112 in the circumferential range 115A of the penetrating groove 115a.

When viewed from the optical axis direction in the camera normal attitude, the lens engagement portion 116c and the lens receiving surface 117c are disposed on the upper side near the center of the circumferential range 115C of the penetrating groove 115c.

In this embodiment, three lens engagement portions and three lens receiving surfaces are provided at approximately regular intervals, so that the first lens 111 is held in a well-balanced manner in the first lens holding frame 112.

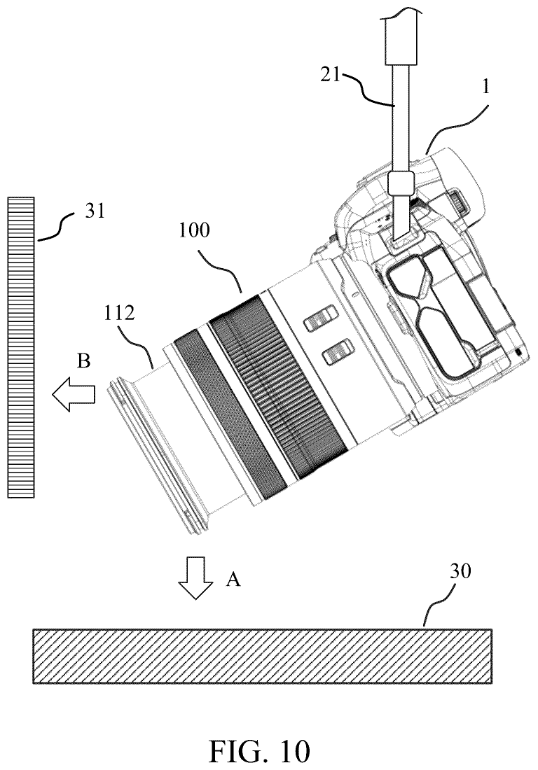

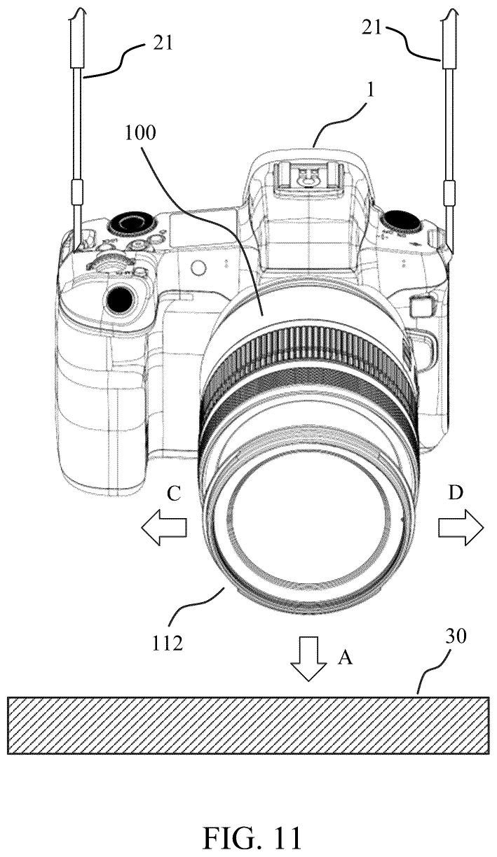

Next follows a description of the impact applied to the interchangeable lens 100. FIG. 10 is a side view of the camera system hung by a strap 21. FIG. 11 is a front view of the camera system hung by the strap 21.

In a case where the camera system collides against ground 30 or the like while hung by the strap 21, the interchangeable lens 100 will fall to the ground 30 along an arrow A due to the positional relationship of the strap 21 relative to the camera body 1. As described above, the accessory attachment portion 118 is provided on a part of the outermost circumference of the first lens holding frame 112, and is located outside the lens holder 113a in the optical axis direction. Therefore, the interchangeable lens 100 falls from the accessory attachment portion 118 and receives the greatest impact from the circumferential range 115A.

In a case where the camera system collides against a wall 31 or the like while suspended by the strap 21, the interchangeable lens 100 collides against the wall 31 along arrows B, C, and D. Therefore, the interchangeable lens 100 is subjected to impact from the circumferential ranges 115B, 115C, and 115D.

In this embodiment, as described above, when viewed from the optical axis direction in the camera normal attitude, the first lens 111 does not contact the first lens holding frame 112 in the circumferential range 115A of the penetrating groove 115a provided on the lower side. The penetrating groove 115a causes the first lens holding frame 112 to elastically deform. Therefore, even if the camera system collides against the ground 30 or the like while suspended by the strap 21 and receives a strong impact, the impact is less likely to be transmitted to the first lens 111, and the first lens 111 is less likely to get damaged.

As described above, when viewed from the optical axis direction in the camera normal attitude, the penetrating grooves 115b, 115c, 115d on the upper and left and right sides are provided within the circumferential ranges 115B, 115C, and 115D, respectively, and the first lens holding frame 112 is elastically deformable. Therefore, even if the camera system collides with the wall 31 or the like while suspended by the strap 21 and receives an impact, the impact is unlikely to be transmitted to the first lens 111, and the first lens 111 is less likely to get damaged.

Since there is no need to add parts to absorb impact, the number of parts and the size of the outermost diameter of the interchangeable lens 100 can be reduced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can provide a holding member that can reduce damage to a lens when an impact or the like is applied.

This application claims the benefit of Japanese Patent Application No. 2024-114264, which was filed on Jul. 17, 2024, and which is hereby incorporated by reference herein in its entirety.

What is claimed is:

1. A holding member comprising:
a holder configured to hold a lens; and
an outer circumference portion integrally molded with the holder and disposed on an outer circumference of the holder,
wherein the holder has a plurality of penetrating grooves along a circumferential direction, on an outer circumference side of a plurality of contact portions that contact the lens when viewed from an optical axis direction.

2. The holding member according to claim 1, wherein each of the plurality of penetrating grooves has an arc shape.

3. The holding member according to claim 1, wherein the plurality of contact portions include a first contact portion disposed at a position that does not overlap the penetrating grooves in the circumferential direction, and a second contact portion disposed at a position that overlaps one of the penetrating grooves in the circumferential direction, and
wherein the holding member is in a normal attitude, the first contact portion is disposed below the second contact portion.

4. The holding member according to claim 3, wherein the second contact portion is disposed at a center of the one of the penetrating grooves in the circumferential direction. 5 The holding member according to claim 3, wherein each of the plurality of contact portions includes an engagement portion engaged with a part of an outer circumferential surface of the lens, and a receiving surface that contacts the lens in the optical axis direction.

6. The holding member according to claim 1, wherein the plurality of penetrating grooves include four penetrating grooves formed at regular intervals along the circumferential direction, and
wherein in a case where the holding member is in a normal attitude, one of the penetrating grooves located at a bottom has the longest length in the circumferential direction.

7. The holding member according to claim 1, wherein the holder holds the lens by caulking. 8 The holding member according to claim 1, wherein an attachment portion for attaching an accessory is provided on a part of an outer circumference of the outer circumference portion.

9. The holding member according to claim 8, wherein the attachment portion is provided so that the attachment portion does not overlap the holder in the optical axis direction.

10. The holding member according to claim 8, wherein the attachment portion is located on an outermost side.

11. A lens barrel comprising:
a holding member; and
at least one lens,
wherein the holding member includes:
a holder configured to hold one of the at least one lens, and
an outer circumference portion integrally molded with the holder and disposed on an outer circumference of the holder, and
wherein the holder has a plurality of penetrating grooves along a circumferential direction, on an outer circumference side of a plurality of contact portions that contact the one of the at least one lens when viewed from an optical axis direction.

12. The lens barrel according to claim 11, wherein the lens held in the holding member is disposed closest to an object in the optical axis direction.

13. An image pickup apparatus comprising:
a lens barrel; and
an image sensor,
wherein the lens barrel includes:
a holding member, and
at least one lens,
wherein the holding member includes:
a holder configured to hold one of the at least one lens, and
an outer circumference portion integrally molded with the holder and disposed on an outer circumference of the holder, and
wherein the holder has a plurality of penetrating grooves along a circumferential direction, on an outer circumference side of a plurality of contact portions that contact the one of the at least one lens when viewed from an optical axis direction.
